(19) United States
(12) Patent Application Publication
(10) Pub. No.: US 2016/0251031 A1
(43) Pub. Date: Sep. 1, 2016

(54) AUXILIARY FRAME WITH CROSSMEMBER AND SUSPENSION LEG TURRET

(71) Applicant: ZF Friedrichshafen AG, Friedrichshafen (DE)

(72) Inventor: Daniel WOLF, Friedrichshafen (DE)

(21) Appl. No.: 15/027,458

(22) PCT Filed: Sep. 15, 2014
(86) PCT No.: PCT/EP2014/069616

§ 371 Date: Apr. 6, 2016

(30) Foreign Application Priority Data
Oct. 9, 2013 (DE) 10 2013 220 319.5

(51) Int. Cl. B62D 21/11

(52) U.S. Cl. CPC B62D 21/11

(57) ABSTRACT

A subframe that can be fitted onto a vehicle body. The subframe comprises an axle support beam (101) and at least one suspension strut turret (105). The subframe is made integrally as one piece and the axle support beam (101) and has at least one elastically designed S-shaped portion (111) which forms a connection point of the subframe to the vehicle body.

This application is a National Stage completion of PCT/EP2014/069616 filed Sep. 15, 2014, which claims priority from German patent application serial no. 10 2013 220 319.5 filed Oct. 9, 2013.

### FIELD OF THE INVENTION

The invention concerns the connection of chassis components to the body of a vehicle by means of a subframe.

### BACKGROUND OF THE INVENTION

To hold chassis components such as transverse and longitudinal control arms and stabilizers, axle support beams are often used. To decouple the body from vibrations and impacts to which the chassis is exposed, the axle support beam is mounted on the body by means of elastic elements such as rubber mountings.

In addition axle support beams of the front axle often also serve for the mounting of aggregates such as the engine and the steering assembly.

The predominant structural form of a steered front axle is the McPherson axle. In this the wheel carriers are each connected to the axle support beam by means of a transverse control arm. Furthermore, each wheel carrier is connected fixed to a suspension strut. Each of the suspension struts comprises a spring and a damper and is fitted and able to rotate in a suspension strut turret. The suspension strut turret is a body structure inside the wheel arch designed to receive the suspension strut.

The trend toward lightweight construction has made it more common to use different materials in the area of the vehicle body. For example, it is known that the spring turrets, which are usually made of sheet steel, can also be produced as light-metal castings and then joined to the sheet structures of the body. In such a multi-material assembly joint sites are involved, in which different material pairings are brought together. That results in a more complex and more expensive production process.

In particular, painting entails demands on the components which often preclude the use of certain materials or make their use more difficult.

From the document DE 10 2006 047 511 A1 an axle system is known, in which the steering assembly is integrated in the axle support beam. This reduces the assembly effort and at the same time brings weight advantages,

In the systems known from the prior art, the attachment of the damper and the spring to the vehicle body is basically problematic. On the one hand vibrations and impacts are transmitted directly into the body at these points, On the other hand assembly is not easy. For example, by virtue of the kinematics of the chassis the points of attachment of the spring and damper to the body can move relative to the attachment points of the axle support beam to the body. Accordingly, the axle support beam and the suspension struts are usually fitted onto the body separately and subsequently joined to one another. In contrast, if the axle support beam and the suspension struts were to be attached to the body in a preassembled condition, i.e. already connected to one another, this would entail precautions to ensure that the springs and dampers were held in position relative to the axle support beam.

### SUMMARY OF THE INVENTION

The purpose of the present invention is to connect the chassis components to a vehicle body in such manner that the disadvantages of the prior art described above are avoided.

That objective is achieved by the invention in accordance with the characteristics specified in the independent claims. Advantageous design features are described in the subordinate claims.

According to the invention, a subframe with an axle support beam that can be mounted on a vehicle body comprises at least one suspension strut turret, preferably exactly two suspension strut turrets. These are preferably arranged on two opposite sides of the vehicle. No part of the subframe is part of the vehicle body, in particular not made integrally with the vehicle body. In particular, this applies to the suspension strut turret.

The vehicle body is in particular the body of a passenger car.

An axle support beam is a preferably rigid subframe that can be mounted on the vehicle body in order to hold at least one chassis component.

Chassis components are means for connecting a wheel to the axle support beam and/or the body, such as transverse control arms, longitudinal control arms, stabilizers, wheel carriers and components of the steering assembly.

Accordingly, the axle support beam according to the invention comprises at least one holder for at least one chassis component, preferably belonging to the front axle but optionally also belonging to the rear axle, in particular a transverse control arm and/or a longitudinal control arm and/or a stabilizer and/or a steering component. In addition the axle support beam can be provided with holding means for the engine and/or for auxiliary aggregates.

A suspension strut turret is understood to mean a device for holding a suspension strut or for holding a shock absorber and/or a spring or spring plate. In particular, the suspension strut turret according to the invention can be a device for holding, in particular for the rotatable mounting, of a McPherson suspension strut.

Since according to the invention the axle support beam and the suspension strut turret are integrated in the subframe, all the attachments points of the axle or chassis components are located on the subframe, In particular, in this way the positions of the individual attachment points relative to one another is defined, This facilitates the fitting of the axle. Moreover, all the attachment points between the subframe and the vehicle body can be provided with elastic mountings so that the body and the axle are mechanically decoupled.

A possible design of the invention is one in which the axle support beam and the suspension strut turret are made separately and then joined to the subframe, for example by bolting, riveting or adhesive bonding.

In a preferred embodiment of the invention, however, the subframe is made integrally, in one piece. Preferably, the subframe consists of a single material. In particular a fiber composite material is suitable, especially one with a through-going fiber structure. As the matrix material a duroplastic such as EP, PU, UP or VE, or a thermoplastic such as PA, PP or PPS can be used. For production by primary forming, fiber-reinforced injection molded granulates, and for production by deformation endless fibers or textile-reinforced semifabricates can be used.

By means of metallic inserts it is possible to reinforce locally or structurally with a fiber composite. To prevent the fiber composite from being damaged by heat, heat-screening baffles can also be provided at sensitive points.

Instead of a fiber composite material, a light metal can also be used for the subframe, which is processed by a primary forming method such as pressure diecasting.

In an also preferred embodiment, a steering housing is integrated in the axle support beam of the integrally made subframe, i.e. the integrally made subframe comprises a steering housing. A steering housing means a housing in which at least one steering component is contained. In particular, the steering housing can contain a steering gear system.

Usually, axle support beams are fitted onto the vehicle body by means of elastic elements, especially elastomer blocks. Another preferred embodiment of the invention provides for the integration of the elastic elements in the axle support beam. Correspondingly, the axle support beam of the integrally formed subframe comprises at least one elastically designed portion.

The portion is made in such manner that compared with the rest of the subframe it has greater elasticity. In particular, the elasticity is greater in an area located along a load path from a wheel through the subframe to the body. Preferably, the portion reacts elastically to translational movements of at least part of the subframe, especially the part of the subframe that does not belong to the elastically designed portion, in one, preferably two, or more preferably still three spatial directions.

Preferably, the elastically designed portion is arranged at a connection point of the subframe to the vehicle body, or it forms a connection point of the subframe to the vehicle body.

To design a portion of the subframe elastically, it has been found advantageous to make part of it in the shape of an S. A fiber composite material is particularly suitable for this.

Furthermore, chassis components can be integrated into the subframe. This results in a further reduction of costs and also simplifies assembly. A further preferred embodiment of the invention is therefore an integrally made subframe in which the axle support beam comprises at least one chassis component.

When a chassis component is integrated in the axle support beam in the manner, there is no need for the joints by means of which the chassis components are usually mounted onto the axle support beam. Instead, the transition zone between the chassis component and the axle support beam is made flexible, In particular, along a rotational axis of the chassis component, the subframe has a lower torsional rigidity compared with the axle support beam. Above all, transverse and/or longitudinal control arms are suitable for integration in the subframe,

In a further preferred embodiment of the invention the subframe comprises at least part of a wheel arch or is designed such that it forms at least part of the wheel arch. Thus, the subframe is at least partially formed as at least part of a wheel arch.

The wheel arch portion and the remainder of the subframe can optionally be made in two pieces and then joined to one another. Preferably however, here too the subframe is made integrally, as one piece. It has been found particularly advantageous for the subframe to comprise a complete wheel arch. Since the wheel arch is then no longer part of the vehicle body, its production is simplified so that further costs are saved. Moreover, a wheel arch integrated in the subframe facilitates the fitting of the subframe.

A method according to the invention for assembling the subframe according to the invention comprises the steps of fitting one or more chassis and/or steering components onto the subframe and then fitting the subframe, with the chassis and/or steering components in place on it, onto the vehicle body. This method is based on the principle of not fitting chassis and/or steering components onto the vehicle body, but rather, onto the subframe according to the invention and then fitting the subframe, together with the already fitted chassis and/or steering components, onto the vehicle body.

The chassis and/or steering components preferably include at least one spring and/or at least one damper. The spring and damper can also be fitted onto the subframe as part of a suspension strut, in particular a McPherson suspension strut, in accordance with the method according to the invention.

In particular, using the method according to the invention it is possible to preassemble a complete axle onto the subframe and then fit it onto the vehicle body. Correspondingly, the chassis and/or steering components include all the chassis and/or steering components of an axle, such as stabilizers, transverse and longitudinal control arms, wheel carriers, suspension struts, spring plates, springs and dampers.

### BRIEF DESCRIPTION OF THE DRAWINGS

Below, an embodiment of the invention is explained with reference to a sole figure. In detail, the sole figure shows an integrally made subframe.

### DETAILED DESCRIPTION OF THE PREFERRED EMBODIMENTS

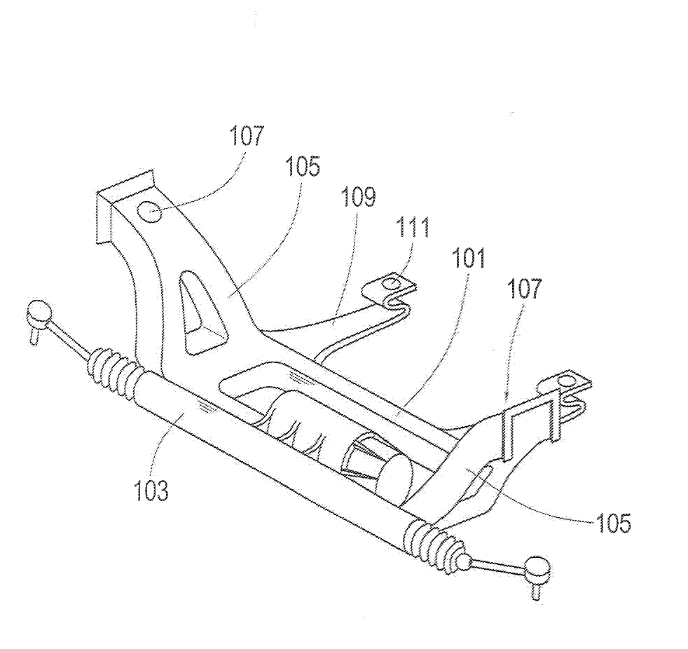

The subframe shown in FIG. 1 comprises an axle support beam 101 with a rectangular basic shape, Integrated in the axle support beam 101 is a steering housing 103. In the outward directions the axle support beam 101 merges into two suspension strut turrets 105 arranged on the two sides of the vehicle. Each of these is provided with a fixture point 107 for a McPherson suspension strut.

To enable it to be attached to a vehicle body, the axle support beam 101 also comprises a longitudinal control arm 109. At its distal end, i.e. at its outer end arranged in the direction of the vehicle body, which is not connected to the rest of the subframe, the arm 109 is provided with an S-shaped spring element 111, The S-shaped spring element 111 serves to absorb impacts and vibrations relative to the vehicle body. Furthermore, the S-shaped spring element 111 is provided with a hole for bolting it onto the vehicle body.

### INDEXES

101 Axle support beam
103 Steering housing
105 Suspension strut turret
107 Suspension strut holding point
109 Longitudinal arm
111 Spring element

1-9. (canceled)

10. A subframe that can be fitted onto a vehicle body, the subframe comprising:
an axle support beam (101), and
at least one suspension strut turret (105),
the subframe being made integrally as one piece and the axle support beam (101) having at least one elastically designed, S-shaped portion (111) which forms a connection point of the subframe to the vehicle body.

11. The subframe according to claim 10, wherein the axle support beam (101) comprises at least one steering housing (103).

12. The subframe according to claim 10, wherein the axle support beam (101) comprises at least one chassis component.

13. The subframe according to claim 10, wherein the subframe either comprises at least part of a wheel arch or is designed such that the subframe forms at least part of a wheel arch.

14. A method of fitting a subframe to a vehicle body, the subframe having an axle support beam (101) and at least one suspension strut turret (105), the subframe being made integrally as one piece and the axle support beam (101) has at least one elastically designed, S-shaped portion (111) forming a connection point of the subframe to the vehicle body, the method comprising:
mounting at least one of chassis and steering components onto the subframe, and
fitting the subframe, with the at one of the chassis an and the steering components mounted thereon, onto the vehicle body.

15. The method according to claim 14, further comprising including at least one of a spring and a damper as the at least one of the chassis and the steering components.

16. The method according to claim 14, further comprising including all chassis and steering components of an axle as the at least one of the chassis and the steering components.
